(19) United States
(12) Patent Application Publication
(10) Pub. No.: US 2011/0087730 A1
(43) Pub. Date: Apr. 14, 2011

(54) Method, Device And System For Creating Instant Messaging System Window

(75) Inventors: Peizhao Li, Shenzhen City (CN); Hong Jiang, Shenzhen City (CN)

(73) Assignee: TENCENT TECHNOLOGY (SHENZHEN) COMPANY LIMITED, Shenzhen City (CN)

(21) Appl. No.: 12/971,545

(22) Filed: Dec. 17, 2010

Related U.S. Application Data
(63) Continuation of application No. PCT/CN2009/072952, filed on Jul. 28, 2009.

(30) Foreign Application Priority Data
Aug. 4, 2008 (CN) 200810142235.9

(51) Int. Cl. G06F 3/048; G06F 15/16

(52) U.S. Cl. 709/203; 715/781

(57) ABSTRACT

Embodiments of this invention provide a method, device and system for creating an IM system window. Specifically, the method includes: pre-loading a dynamic link library and common resource file required for creating an IM system window; and when to create the IM system window for the first time currently, loading a characteristic resource file prepared for the IM system window, and creating the IM system window according to the pre-loaded dynamic link library and common resource file. In the embodiments of the present invention, before the user creates the IM system window for the first time, the dynamic link library and the common resource file required for creating the IM system window are pre-loaded. Hence, when the user creates the IM system window for the first time, the IM system window can be directly created according to the pre-loaded dynamic link library and common resource file.

### CROSS-REFERENCE TO RELATED APPLICATIONS

This application is a continuation of International Application No. PCT/CN2009/072952, filed on Jul. 28, 2009. This application claims the benefit and priority of Chinese Application No. 200810142235.9, filed Aug. 4, 2008. The entire disclosures of each of the above applications are incorporated herein by reference.

### FIELD

The present disclosure relates to the field of computer technologies, and particularly to a method, device and system for creating an Instant Messaging system window.

### BACKGROUND

This section provides background information related to the present disclosure which is not necessarily prior art.

Along with the development of Instant Messaging (IM) techniques, an IM system has become a necessary communication tool in people's work and life. Therefore, it is desired for the user that the IM system could provide improved convenience, stability, speed, and etc.

Client software for the IM system typically includes a main panel used for loading a contact list and various IM system windows used for the user to chat with a contact, e.g., a chatting window, a chatting recordation window, a contact information window, a system setting window, and etc. The user may effectively manage the contact list through the main panel, and may achieve communications and conversation with contacts as well as contact management through various windows. Existing IM software modes all employ a split manner between the main panel and the windows. That is, when the user makes use of the IM software, the IM client software is activated in advance, and after a username and a password are input, the user logs in the IM server, and the contact list is loaded onto the IM's main panel.

If wishing to chat with a contact listed in the main panel, the user may double-click the contact so that a chatting window for the contact is created. On the other hand, if wishing to manage the contact listed in the main panel, the user may create a corresponding window through a menu provided by the IM system to perform a corresponding operation. The process for the existing client software of the IM system to create an IM system window for the first time is shown in FIG. 1. A brief explanation is as follows. When the user clicks a contact's head portrait provided in the IM main panel, firstly a dynamic link library required for creating an IM system window is loaded, then a resource file prepared for the IM system window is loaded, and finally the IM system window is created according to related configuration. This method for creating the IM system window for the first time takes no less than 1.2 s. However, if in a better user experience speed, it would takes 200 ms or less. Hence, such method for creating the IM system window for the first time takes too much time, thus it is difficult for the IM system to achieve better user experiences and to meet the user's requirement for speed.

### SUMMARY

This section provides a general summary of the disclosure, and is not a comprehensive disclosure of its full scope or all of its features.

Embodiments of the present invention provide a method, device and system for creating an Instant Messaging system window, so as to increase the speed of creating the IM system window for the first time.

The technical solutions provided by the embodiments of the present invention are implemented as follows.

A method for creating an Instant Messaging, IM, system window, which includes:
pre-loading a dynamic link library and a common resource file required for creating an IM system window; and,
when to create the IM system window for the first time currently, loading a characteristic resource file required for the IM system window, and creating the IM system window according to the pre-loaded dynamic link library and the common resource file.

A device for creating an IM system window, which includes a pre-loading unit and a window creating unit, wherein
the pre-loading unit is adapted to pre-load a dynamic link library and a common resource file required for creating an IM system window, and to load a corresponding characteristic resource file after receiving a loading notification sent from the window creating unit; and,
the window creating unit is adapted to send the loading notification to the pre-loading unit when to create the IM system window for the first time currently, and to create the IM system window according to the dynamic link library and the common resource file pre-loaded by the pre-loading unit.

An IM system, which includes the above device.

In the embodiments of the present invention, before the user creates an IM system window for the first time, a dynamic link library and a common resource file required for creating the IM system window are pre-loaded. Hence, when the user creates the IM system window for the first time, the IM system window can be directly created according to the pre-loaded dynamic link library and common resource file, thus avoiding the problems in the prior art resulted from loading the dynamic link library and the resource file only when the IM system window is being created, and increasing the speed of creating the IM system window for the first time. In the embodiments of the present invention, no interior modification is carried out for the internal structure of the IM system window. Since the dynamic link library and the common resource file required for creating the IM system window are loaded in advance, the time taken in opening the IM system window for the first time can be reduced to 200 ms, thus increasing the speed of creating the IM system window and achieving better user experiences.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart illustrating implementation of a method for creating an IM system window according to the prior art;

FIG. 2 is a flow chart illustrating implementation of a method for creating an IM system window according to an embodiment of the present invention; and,

FIG. 3 is a schematic diagram illustrating a structure of a device for creating an IM system window according to an embodiment of the present invention.

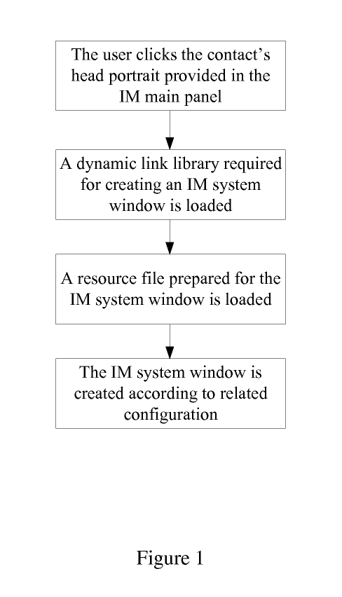

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The method provided by the embodiments of the present invention mainly includes: pre-loading a dynamic link library and a common resource file required for creating an IM system window, loading a characteristic resource file prepared for the IM system window when the IM system window is to be created for the first time currently, and creating the IM system window according to the pre-loaded dynamic link library and the common resource file. As can be seen, the pre-loading operation is introduced in the embodiments of the present invention, so that the speed of creating the IM system window for the first time can be increased and better user experiences can be achieved.

To make the objects, technical solutions and advantages of the present invention more apparent, the present invention is described in further detail hereinbelow with reference to the embodiments and the accompanying drawings.

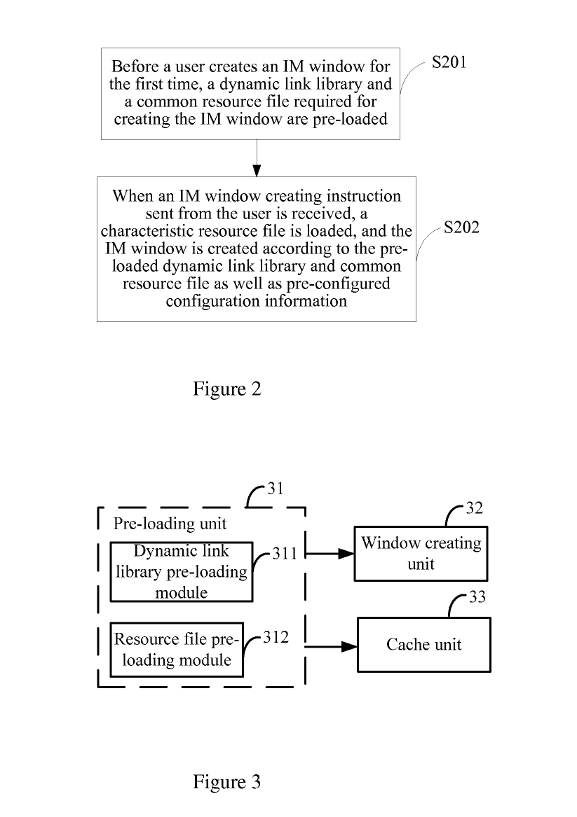

Referring to FIG. 2, it is a flow chart illustrating the implementation of the method for creating the IM system window according to an embodiment of the present invention. Here, in order to facilitate description, the IM system window is referred to as an IM window in the embodiment. As shown in FIG. 2, the procedure may include steps as follows.

In Step S201, before a user creates an IM window for the first time, a corresponding dynamic link library and a common resource file required for creating the IM window are pre-loaded.

In the embodiment of the present invention, the IM window includes, but is not limited to, at least one of a chatting window, a chatting recordation window, a contact information window, a system configuration window, and etc.

Here, the dynamic link library is a required resource configuration file in creating the IM window for the first time. Different IM windows correspond to different dynamic link libraries. For example, the chatting window and the system configuration window correspond to different dynamic link libraries from each other. The common resource file refers to at least one resource file required in common in creating respective windows (e.g., the chatting window, the chatting recordation window, etc.) included in the IM window of the IM system, and the common resource file includes, but is not limited to, a cutting plan for a button, a cutting plan for a window panel, and etc.

Preferably, in order to improve the whole efficiency of the IM system, it may be arranged that only the dynamic link library and the common resource file corresponding to part of the windows included in the IM window are pre-loaded. For example, since the chatting window, which mainly includes a group window and a friend window, is a frequently-used window for the user, the dynamic link library and the common resource file corresponding to the chatting window may preferably be pre-loaded in Step S201 according to the embodiment of the present invention.

Typically, the IM system may include an IM client and an IM server. In the embodiment of the present invention, when the IM client's software is started, a pre-loading thread may be created, and the corresponding dynamic link library and common resource file required for creating the IM window are loaded via the pre-loading thread. It is known for those skilled in this art that, time for better user experiences is no more than 200 ms. In order to enhance the improved user experience, it is preferable in the embodiment of the present invention that when the IM client's software is started, at least two pre-loading threads are created according to the quantity and magnitude of the shared resource file(s), where, one is used for loading the corresponding dynamic link library required for creating the IM window, and the remaining is used for loading the corresponding common resource file required for creating the IM window.

Preferably, in another embodiment of the present invention, it may be arranged that: when the IM client's software is started, a pre-loading thread is created, and the corresponding dynamic link library required for creating the IM window is loaded via the pre-loading thread; and when the IM client logs in to the IM server, at least one pre-loading thread is created, so as to pre-load the corresponding common resource file required for creating the IM window. Alternatively, when the IM client's software is started, at least one pre-loading thread is created, so as to pre-load the corresponding common resource file required for creating the IM window; and when the IM client logs in to the IM server, a pre-loading thread is created, and the corresponding dynamic link library required for creating the IM window is loaded via the pre-loading thread. In other words, the dynamic link library and the common resource file are arranged in a certain pre-loading sequence.

It should be noted that, in the embodiment of the present invention, the pre-loading operation for the dynamic link library and the common resource file may also be carried out during the IM client logging in to the IM server. There is no particular limit to the embodiment of the present invention. Therefore, the forgoing is merely exemplary, and is not in any way to limit the application of the embodiment of the present invention.

Since the IM client and the IM server need to interact with each other as the IM client logs in to the IM server via the IM client's software, the IM client is waiting for a response message from the IM server in certain time periods during the login process. Preferably, in another embodiment of the present invention, in order to improve the operation efficiency of the CPU where the IM client is located and to reduce the load on the CPU that is resulted from the IM software, the common resource file required for creating the IM window may be pre-loaded via the created pre-loading thread when the IM client is in a relatively idle state. Specifically, a method for determining whether the IM client is idle may include directly determining whether the utilization rate of the CPU is high, or the like. If the utilization rate of the CPU is relatively low, it is determined that the IM client is in a idle state. At this time, the common resource file required for creating the IM window is pre-loaded via the created pre-loading thread. If the utilization rate of the CPU is relatively high, it is determined that the IM client is not in a idle state. At this time, pre-loading the common resource file required for creating the IM window via the created pre-loading thread may be suspended. Preferably, the method for determining whether the utilization rate of the CPU is high may be implemented in various manners, e.g., a predetermined value for evaluating the utilization rate of the CPU may be estimated according to the operation efficiency of the CPU. Preferably, in the embodiment, the predetermined value for evaluating the utilization rate of the CPU may be 10%. Thus, whether the current utilization rate of the CPU is larger than the predetermined value may be determined, e.g., whether the current utilization rate of the CPU is larger than 10% is determined. If the determination leads to a positive result, it is determined that the utilization rate of the CPU is high, and otherwise, it is determined that the utilization rate of the CPU is low.

It should be noted that, in the embodiment of the present invention, in order to avoid the situation that the dynamic link library and the common resource file required for creating the IM window is read out from a disk when the IM window is created for the first time (which causes the creation of the IM window takes too much time), the loaded dynamic link library and common resource file may be cached in a memory after the dynamic link library and the common resource file required for creating the IM window are loaded.

In Step S202, when an IM window creating instruction sent from the user is received, a corresponding characteristic resource file is loaded, and the IM window is created according to the pre-loaded dynamic link library and common resource file as well as pre-configured relevant configuration information.

Specifically, the characteristic resource file refers to a resource file relevant to a particular contact, and includes, but is not limited to, a self-defined head portrait, a personalized signature, and etc.

In the embodiment of the present invention, the user may send the IM window creating instruction in accordance with any method for sending the IM window creating instruction provided in the prior art. For example, the IM window creating instruction may be sent either by double-clicking the contact's head portrait provided in the main panel of the IM system, or by right-clicking the contact's head portrait provided in the main panel of the IM system and then selecting a menu item of “sending an instant message”, or the like. As can be seen, information on the IM window to be created for the first time is carried in the IM window creating instruction. Thus, after the IM window creating instruction is received, the corresponding IM window may be created directly. It should be noted that, if the IM window creating instruction currently received carries information which indicates that the IM window to be created for the first time includes at least one of a chatting window, a chatting recordation window, a contact information window, a system configuration window, e.g., includes a chatting window, creating the IM system window according to the pre-loaded dynamic link library and common resource file in Step S202 includes: the dynamic link library and the common resource file prepared for the chatting window to be created for the first time currently are determined from the pre-loaded dynamic link library and common resource file, and the chatting window to be created currently is created using the determined dynamic link library and common resource file as well as pre-configured configuration information for the chatting window.

Thus, the procedure of the method for creating the IM system window according to the embodiment of the present invention is implemented by the above operations.

The device and the system according to the embodiment of the present invention are described hereinbelow.

Referring to FIG. 3, it is a schematic diagram illustrating a structure of a device for creating an IM system window according to an embodiment of the present invention. In order to facilitate description, only parts relevant to the embodiment of the present invention are illustrated. The device for creating the IM system window may be a software unit, a hardware unit or a combination thereof built in the IM system. There is no particular limit to the embodiment of the present invention. As shown in FIG. 3, the device may include: a pre-loading unit 31 and a window creating unit 32.

The pre-loading unit 31 is adapted to pre-load a corresponding dynamic link library and a common resource file required for creating the IM window before a user creates the IM window for the first time. Specifically, the common resource file refers to a public resource file of the IM system window, and includes, but is not limited to, a cutting plan for a button, a cutting plan for a window panel, and etc. In the embodiment of the present invention, the IM system window includes, but is not limited to, at least one of a chatting window, a chatting recordation window, a contact information window, a system configuration window, and etc.

The pre-loading unit 31 is further adapted to load a corresponding characteristic file after receiving a loading notification sent from the window creating unit 32. Specifically, the characteristic resource file refers to a resource file relevant to a particular contact, and includes, but is not limited to, a self-defined head portrait, a personalized signature, and etc.

The window creating unit 32 is adapted to send the loading notification to the pre-loading unit 31 when the IM system window is to be created for the first time currently, and to create the IM system window according to the dynamic link library and the common resource file pre-loaded by the pre-loading unit 31. Here, an indication for the IM system window to be created for the first time currently is carried in an IM system window creating instruction sent from the user.

Preferably, as shown in FIG. 3, the pre-loading unit 31 may include a dynamic link library pre-loading module 311 and a resource file pre-loading module 312.

Specifically, the dynamic link library pre-loading module 311 is adapted to pre-load the dynamic link library required for creating the IM system window when an IM system is started or when an IM client logs in to an IM server; and, the resource file pre-loading module 312 is adapted to pre-load the common resource file required for creating the IM system window when the IM system is started or when the IM client logs in to the IM server.

Preferably, as shown in FIG. 3, the device further includes a cache unit 33.

Specifically, the cache unit 33 is adapted to cache the dynamic link library and the common resource file required for creating the IM system window that are loaded by the dynamic link library pre-loading module 311 and the resource file pre-loading module 312 respectively.

Those ordinarily skilled in the art will understand that, all or part of the steps used for implementing the method according to the above embodiments may be embodied in a way as instructing relevant hardware by a program. The program may be stored in a computer readable storage medium, e.g., an ROM/RAM, a magnetic disk, an optical disk, and etc.

The forgoing is an explanation for the structure of the device for creating the IM system window according to the embodiment of the present invention.

Preferably, the embodiments of the present invention further include an IM system. The IM system includes the aforementioned device for creating the IM system window.

In the embodiments of the present invention, before the user creates an IM system window for the first time, the dynamic link library and the common resource file required for creating the IM system window are pre-loaded. Hence, when the user creates the IM system window for the first time, the IM system window can be directly created according to the pre-loaded dynamic link library and common resource file, thus avoiding the problems in the prior art resulted from loading the dynamic link library and the resource file only when the IM system window is being created, and increasing the speed of creating the IM system window for the first time. In the embodiments of the present invention, no interior modification is carried out for the internal structure of the IM system window. Since the dynamic link library and the common resource file required for creating the IM system window are loaded in advance, the time taken in opening the IM system window for the first time can be reduced to 200 ms, thus increasing the speed of creating the IM system window and achieving better user experiences.

Further, in the embodiments of the present invention, when the dynamic link library and the common resource file required for creating the IM system window are pre-loaded, the common resource file required for creating the IM system window is loaded and cached when the IM client is in a relatively idle state, thus reducing the load on the CPU of the IM client significantly.

The foregoing is merely preferred embodiments of the present invention, and the scope of the present invention is not limited thereto. Any modifications, equivalents or improvements made without departing from the spirit and principle of the present invention are intended to fall into the scope of the present invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for creating an Instant Messaging, IM, system window, the method comprising:
pre-loading a dynamic link library and a common resource file required for creating an IM system window; and,
when to create the IM system window for the first time currently, loading a characteristic resource file required for the IM system window, and creating the IM system window according to the pre-loaded dynamic link library and the common resource file.

2. The method according to claim 1, wherein, said pre-loading a dynamic link library and a common resource file required for creating the IM system window comprises:
loading the dynamic link library and the common resource file required for creating the IM system window when an IM system is started; or,
when an IM system comprises an IM client and an IM server, loading the dynamic link library and the common resource file required for creating the IM system window when the IM client logs in to the IM server; or,
when an IM system comprises an IM client and an IM server, loading the dynamic link library required for creating the IM system window when the IM system is started, and loading the common resource file required for creating the IM system window when the IM client logs in to the IM server; or,
when an IM system comprises an IM client and an IM server, loading the common resource file required for creating the IM system window when the IM system is started, and loading the dynamic link library required for creating the IM system window when the IM client logs in to the IM server.

3. The method according to claim 2, wherein, said loading the dynamic link library and the common resource file, or the common resource file, or the dynamic link library, required for creating the IM system window when the IM client logs in to the IM server comprises:
determining whether the IM client is in a relatively idle state, and if so, executing the process of loading the dynamic link library and the common resource file, or the common resource file, or the dynamic link library, required for creating the IM system window.

4. The method according to claim 1, wherein after said loading a dynamic link library and a common resource file required for creating the IM system window, the method further comprises:
caching the loaded dynamic link library and the common resource file required for creating the IM system window.

5. The method according to claim 1, wherein the IM system window comprises at least one of a chatting window, a chatting recordation window, a contact information window, and a system configuration window.

6. The method according to claim 5, wherein, the IM system window to be created for the first time currently comprises at least one of the chatting window, the chatting recordation window, the contact information window, and the system configuration window;
said pre-loading a dynamic link library and a common resource file required for creating an IM system window comprises:
pre-loading dynamic link libraries and common resource files respectively required for creating the chatting window, the chatting recordation window, the contact information window, and the system configuration window;
said creating the IM system window according to the pre-loaded dynamic link library and common resource file comprises:
determining the dynamic link library and the common resource file required for creating the IM system window for the first time currently from the pre-loaded dynamic link libraries and common resource files; and,
creating the IM system window to be created currently using the determined dynamic link library and common resource file as well as pre-configured window configuration information.

7. A device for creating an IM system window, characterized by, the device comprising a pre-loading unit and a window creating unit, wherein,
the pre-loading unit is adapted to pre-load a dynamic link library and a common resource file required for creating an IM system window, and to load a corresponding characteristic resource file after receiving a loading notification sent from the window creating unit; and,
the window creating unit is adapted to send the loading notification to the pre-loading unit when to create the IM system window for the first time currently, and to create the IM system window according to the dynamic link library and the common resource file pre-loaded by the pre-loading unit.

8. The device according to claim 7, wherein the pre-loading unit comprises:
a dynamic link library pre-loading module, adapted to pre-load the corresponding dynamic link library required for creating the IM system window when an IM system is started or when an IM client logs in to an IM server; and,
a resource file pre-loading module, adapted to pre-load the corresponding common resource file required for creating the IM system window when the IM system is started or when the IM client logs in to the IM server.

9. The device according to claim 8, wherein, the device further comprises a cache unit, wherein,
the cache unit is adapted to cache the dynamic link library and the common resource file required for creating the IM system window which are respectively loaded by the dynamic link library pre-loading module and the resource file pre-loading module.

10. An IM system, characterized by, the IM system comprising the device for creating an IM system window according to claim 7.
